(19) United States
(12) Patent Application Publication
(10) Pub. No.: US 2013/0277945 A1
(43) Pub. Date: Oct. 24, 2013

(54) SWEPT TORSION HITCH TUBE

(71) Applicant: Richard McCoy, Granger, IN (US)

(72) Inventor: Richard McCoy, Granger, IN (US)

(73) Assignee: CEQUENT PERFORMANCE PRODUCTS, INC., Plymouth, MI (US)

(21) Appl. No.: 13/816,150

(22) PCT Filed: Aug. 8, 2011
(86) PCT No.: PCT/US2011/046927

§ 371 Date: Jul. 11, 2013

Related U.S. Application Data
(60) Provisional application No. 61/371,736, filed on Aug. 8, 2010.

(51) Int. Cl. B60D 1/48

(52) U.S. Cl. CPC B60D 1/488
USPC 280/495

(57) ABSTRACT

A hitch assembly is generally provided. The hitch assembly may include at least one bracket capable of being secured to a vehicle, and a torsion tube having a length and being attached to the at least one bracket. The torsion tube being curved at a substantially constant radius substantially along the length of the torsion tube.

### CROSS-REFERENCE TO RELATED APPLICATION

This application claims benefit from U.S. Provisional Patent Application No. 61/371,736, entitled “Swept Torsion Hitch Tube,” filed on Aug. 8, 2010, which is hereby incorporated in its entirety by reference.

### TECHNICAL FIELD

The present invention generally relates to a hitch tube and, more particularly, to a swept torsion hitch tube.

### BACKGROUND

Trailer hitch assemblies are traditionally designed to be mounted to vehicles to allow the towing of trailers or the like. Towing heavy payloads such as boats, campers, and trailers can create considerable stress between the hitch assembly and the vehicle. Hitch assemblies are typically bolted directly to the towing vehicle's frame so as to attempt to distribute the considerable stress over the vehicle frame.

Some current prior art trailer hitch assemblies include a central frame member or crossbar having mounting brackets connected at each end for mounting the trailer hitch assembly to the frame of the towing vehicle. A receiver box having a rearwardly facing opening or cavity is often mounted to the crossbar for the receipt of a hitch or draw bar that carries a hitch ball or other means of allowing connection to a trailer.

Crossbars, or torsion tubes, are traditionally designed to be generally straight and shaped to engage a similarly shaped bumper. Commonly, torsion tubes are designed or modified to avoid under-body structures such as an exhaust system. To accommodate the structures, torsion tubes often include one or more bends or angles in the tube to clear the under-body structures and position the receiver box at the desired location. This design, however, has several drawbacks.

First, bending or angling the torsion tube may reduce the tubes overall strength. For example, the bends and angles can lead to stress risers in the tube causing fatigue at given locations. Second, the bent and angled design requires multiple bends to be formed in the tube, adding both time and cost to the manufacturing process. Finally, while the traditional bent design of the torsion tube is capable of engaging the bumper, the overall design lacks aesthetic cleanliness and visual appeal.

Therefore, there is a need for an improved hitch assembly having an appropriately shaped torsion tube.

### SUMMARY

A hitch assembly may include at least one bracket capable of being secured to a vehicle, and a torsion tube having a length and being attached to the at least one bracket. The torsion tube being curved at a substantially constant radius substantially along the length of the torsion tube.

In an alternative embodiment, a hitch assembly may include at least one bracket capable of attaching to a vehicle, a torsion tube having first and second end portions, where at least one of the first and second end portions is attached to the at least one bracket and where at least a portion of the torsion tube is curved and the curve has a substantially constant radius.

In yet another alternative embodiment, a hitch assembly may include at least one frame bracket capable of attaching to a vehicle, a torsion member having a length and being attached to the at least one frame bracket, wherein the torsion member being curved at a substantially constant radius along at least a portion of the length. The hitch assembly may further include a receiver assembly attached to the torsion member.

### DESCRIPTION OF THE DRAWINGS

The operation of the invention may be better understood by reference to the following detailed description taken in connection with the following illustrations, wherein:

FIG. 1 is a perspective of a vehicle having a hitch assembly attached thereto.

FIG. 2 is a front perspective view of the hitch assembly of claim 1.

FIG. 3 is a rear perspective view of the hitch assembly.

FIG. 4 is a plan view of the hitch assembly.

FIG. 5 is a bottom view of the hitch assembly.

FIG. 6 is a front view of the hitch assembly.

FIG. 7 is an elevation view of the hitch assembly.

FIG. 8 is a perspective view of a torsion tube of the hitch assembly.

FIG. 9 is a plan view of a torsion tube of the hitch assembly.

FIG. 10 is a front view of a torsion tube of the hitch assembly.

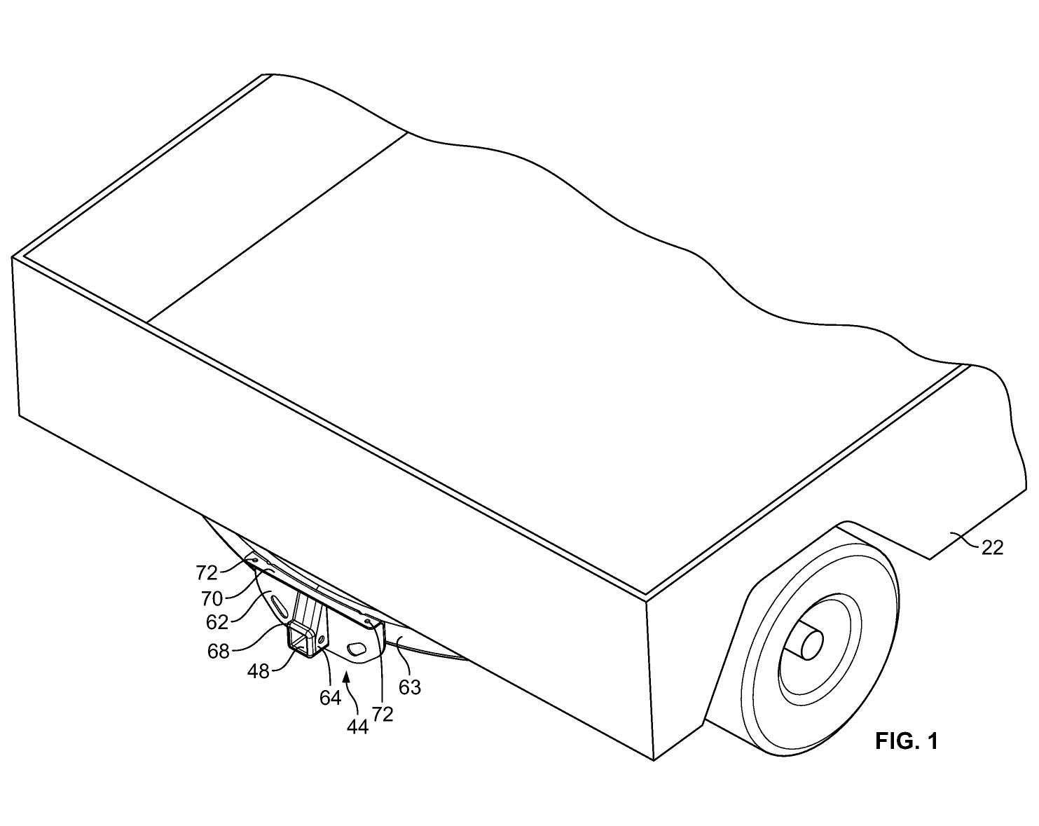

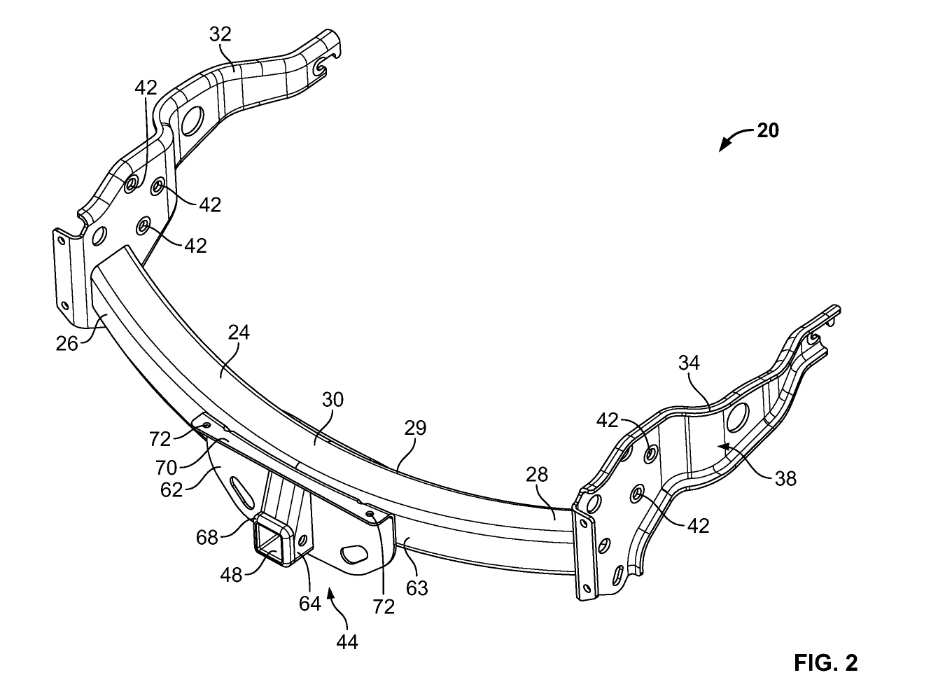

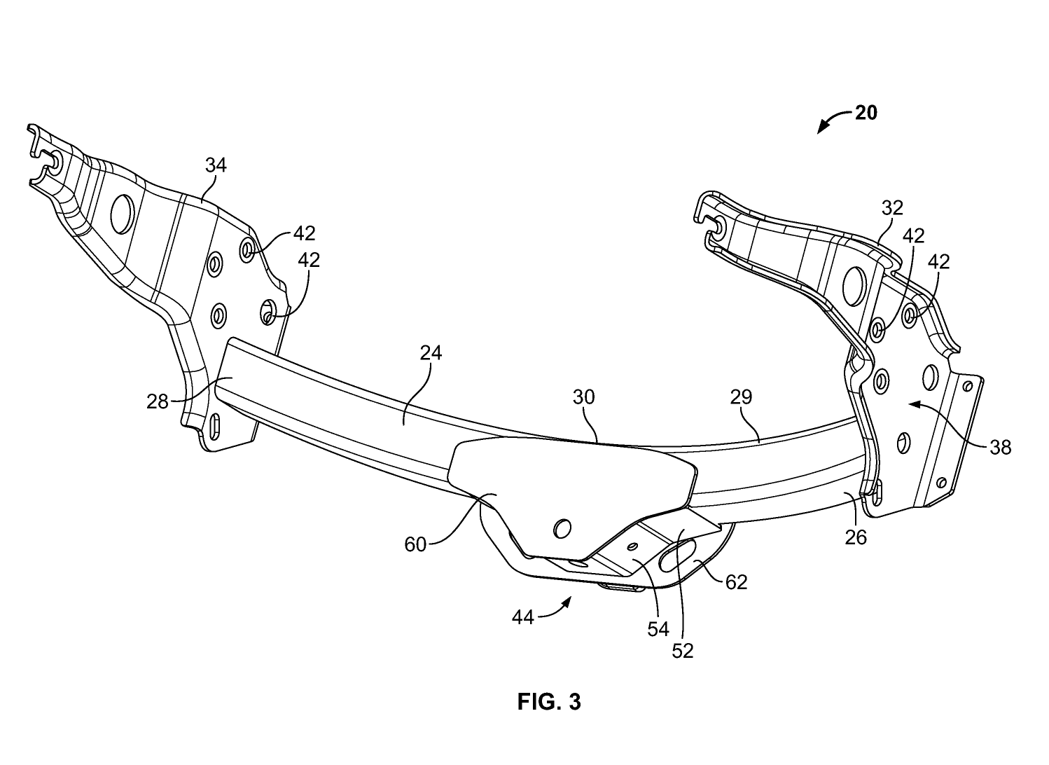

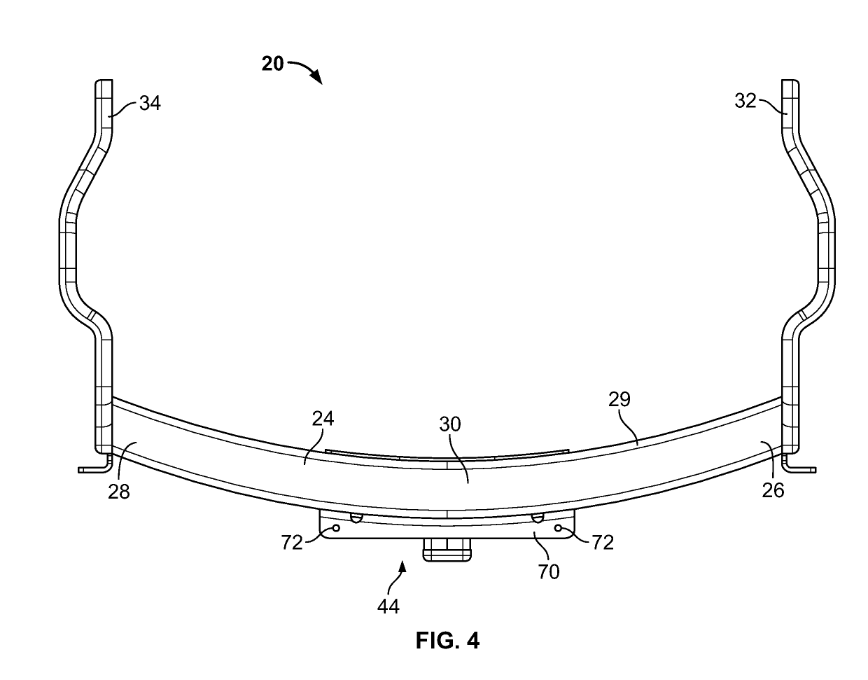

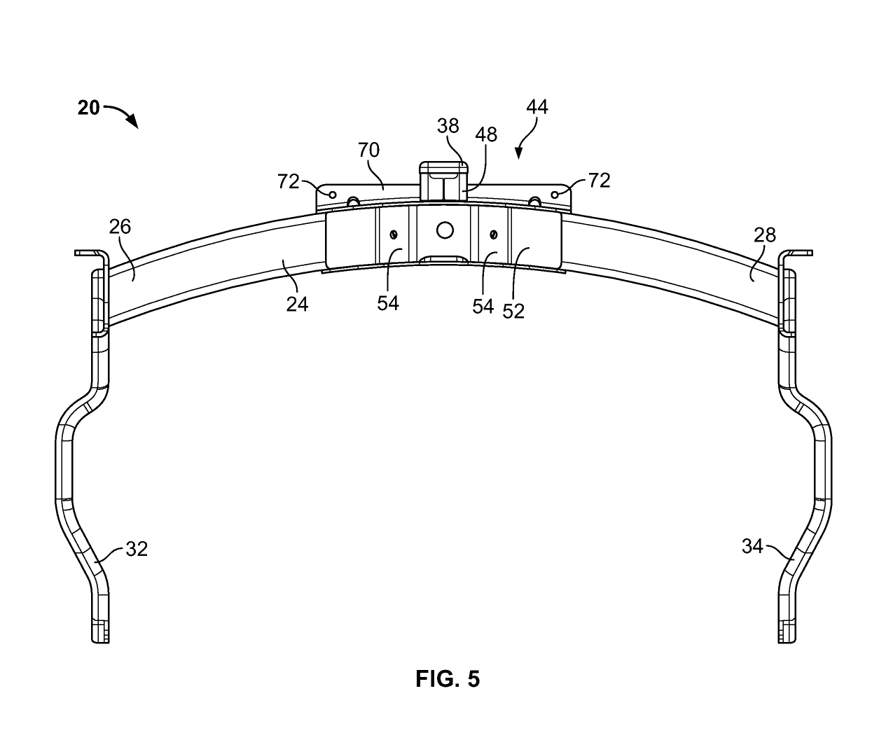

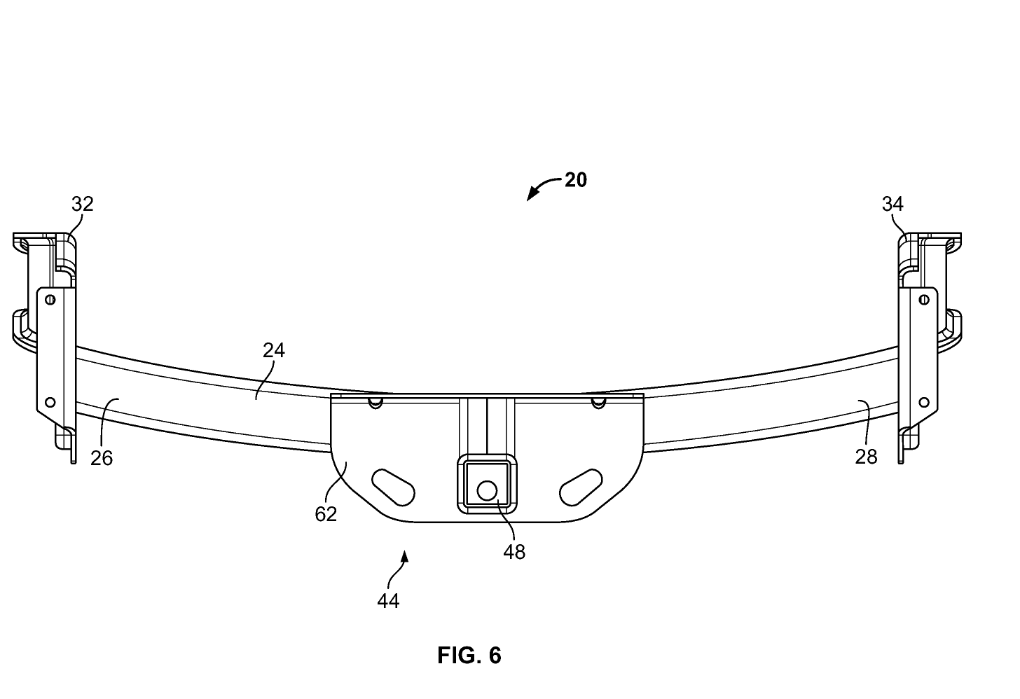

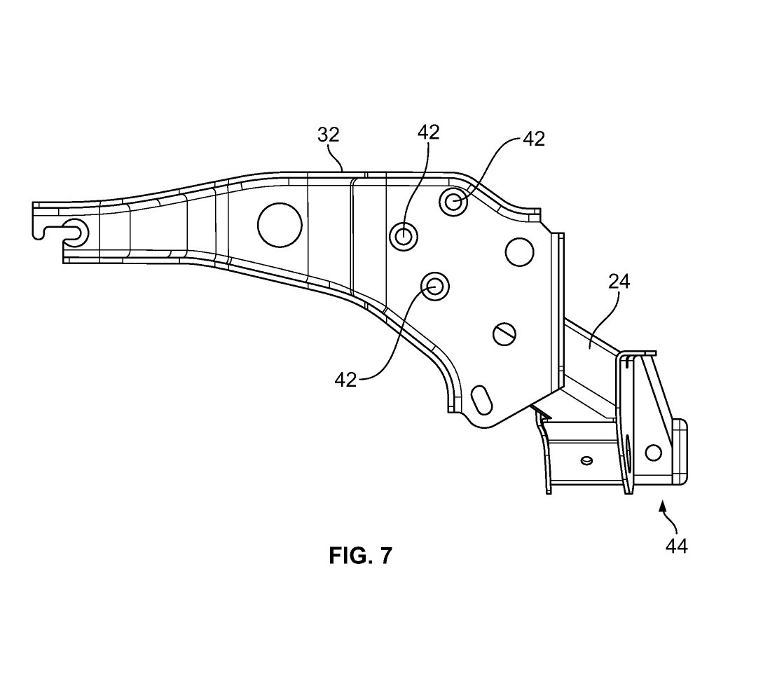

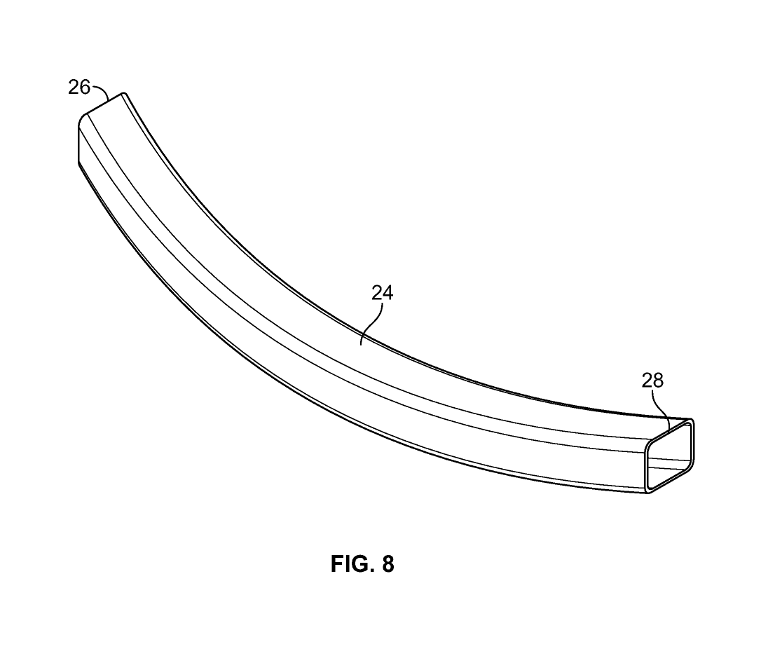

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A hitch assembly 20 is generally provided. The hitch assembly 20 is configured to facilitate attachment of a towing vehicle 22 to a towed vehicle (not shown), such as, for example, a boat, camper, trailer or the like. The hitch assembly 20 may attach to the towing vehicle frame (not shown), and may be configured to receive or connect to hitch components, such as a hitch bar, draw bar, hitch ball, or other hitch components as are known in the art.

The hitch assembly 20 may include a crossbar or torsion tube 24 that generally spans the length of the hitch assembly 20. The torsion tube 24 may be positioned between portions of a vehicle frame and connected thereto using other components, as further described below. The torsion tube 24 may include a first end 26 and a second end 28. As illustrated in the drawings, the torsion tube 24 may be a tubular member having a generally square or rectangular cross-section. However, it will be appreciated that the torsion tube 24 may have any cross-sectional shape, such as circular, ovular, or any other appropriate shape.

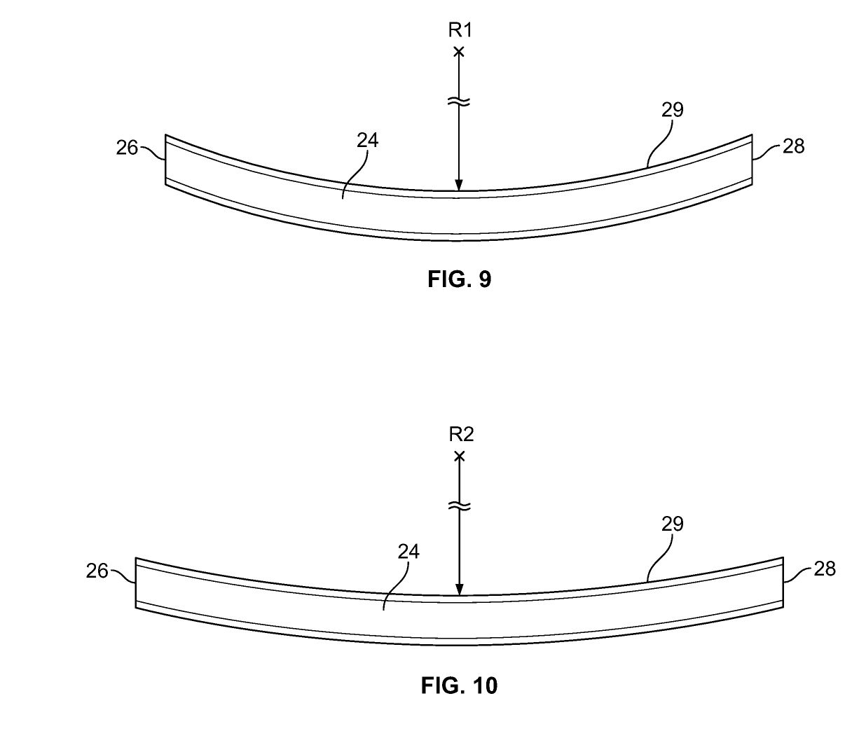

The geometry and profile of the torsion tube 24 may be designed to provide clearance of under-body obstructions on the vehicle 22 while potentially increasing the strength and aesthetic appeal of the torsion tube 24. To that end, the torsion tube 24 may include a curved profile 29, as best illustrated in FIGS. 9-10. The curved profile 29 of the torsion tube 24 may extend from the first end 26 to the second end 28 at a constant radius. Alternatively, the curved profile 29 may be localized to a specific portion, such as a central portion 30 of the torsion tube 24. Further, in an alternative embodiment, the radius of the curved portion 29 may vary over the length of the torsion tube 24.

The torsion tube 24 may be curved in one or more planes. For example, as illustrated in the plan view of FIG. 9, the torsion tube 24 may have a radius of curvature R1 in a horizontal plane. As illustrated in the elevation view of FIG. 10, the torsion tube 24 may further have a radius of curvature R2 in a vertical plane. However, it will be appreciated that curvature of the torsion tube 24 is not limited to a horizontal or vertical plane but may be curved in any plane relative to the torsion tube 24. Moreover, the torsion tube 24 may be curved in multiple planes, such as both the horizontal plane shown in FIG. 9 and vertical plane shown in FIG. 10. The radius of curvature in each plane may be independently defined and therefore may be either equal to or different than the radius of curvature in the other plane or planes.

The hitch assembly 20 may include frame brackets, which may be capable of connecting the hitch assembly 20 to the vehicle 22. By way of a non-limiting example, the hitch assembly 20 may include a first frame bracket 32, which may be connected to the first end 26 of the torsion tube 24, and a second frame bracket 34, which may be connected to the second end 28. The first and second frame brackets 32, 34 may be configured to engage a portion of the frame of the vehicle 22. For example, one or more flanged surfaces 38 may extend from the first and second frame brackets 32, 34 and engage a similarly shaped surface of the frame of the vehicle 22. The first and second frame brackets 32, 34 may further include a plurality of bolt holes 42 for bolting, fastening or otherwise securing the first and second brackets 32, 34 to the frame of the vehicle 22. However, it will be appreciated that the first and second frame brackets 32, 34 may be secured to the frame of the vehicle 22 by any means known in the art and is not limited to that shown or described herein.

A receiver assembly 44 may be secured to a portion of the torsion tube 24, such as at the central portion 31 of the torsion tube 24. The receiver assembly 44 may include a hitch box or receiver tube 48. The receiver tube 48 may be generally hollow and configured to accept a hitch bar or draw bar therein. The receiver tube 48 may be welded, bolted, or otherwise connected to the torsion tube 24. While the receiver tube 48 is shown and described herein as being generally hollow and having a generally square or rectangular cross-section, it is not limited to such and may be any appropriate shape and size. Moreover, the present teachings are not limited to the receiver tube 48 shown and described herein; any kind of hitching member may be used.

The receiver assembly 44 may further include a plurality of plates 52 that may facilitate connection of the receiver tube 48 to the torsion tube 24 and may assist in connecting the hitch assembly 20 to the vehicle 22. A channel support 54 may be mounted underneath the receiver tube 48 so that it may strengthen the connection between the receiver tube 48 and the torsion tube 24. A back plate 60 may be mounted behind the receiver tube 48 and may be connected to the torsion tube 24. Further, a chain plate 62 may be mounted to a front portion 63 of the torsion tube 24 and may surround the receiver tube 48. The chain plate 62 may include one or more reinforcements 64 that may engage a collar 68 on the receiver tube 48 so that they may provide additional support. The chain plate 62 may further include a top flange 70 having one or more apertures 72 for connecting the receiver assembly 44 to a portion of the vehicle 22, such as to the underside of the vehicle in close proximity to the bumper or directly to the bumper of the vehicle.

The receiver assembly 44 may be adapted to specifically engage the curved profile 29 of the torsion tube 24. By way of a non-limiting example, the receiver tube 48 may be curved or angled to substantially conform to the curve and/or angle of the torsion tube 24 at the desired attachment point. Further, the channel support 54, back plate 60 and chain plate 62 may all be curved or angled to similarly engage the torsion tube 24 and may be of a generally equal curve and/or angle. Moreover, the receiver assembly 44 may include shims (not shown) and/or other additional components to tailor the engagement of the receiver assembly 44 to the torsion tube 24.

The curved or swept profile 29 of the torsion tube 24 may enhance the overall strength of the torsion tube 24. By way of a non-limiting example, the curved profile 29 may substantially eliminate stress risers that may otherwise result from localized bends and angles of presently used torsion tubes. The curved profile 29 of the torsion tube 24 may also generally eliminate manufacturing processes that may be costly and time consuming. Finally, the curved profile 29 of the torsion tube 24 may be clean, have arced lines that may be more aesthetically pleasing than previously designed torsion tubes.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof

Having thus described the invention, we claim:

1. A hitch assembly comprising:
at least one bracket capable of being secured to a vehicle; and
a torsion tube having a length and being attached to the at least one bracket, wherein the torsion tube is curved at a substantially constant radius substantially along the length of the torsion tube.

2. The hitch assembly of claim 1, wherein the torsion tube is curved in only one plane.

3. The hitch assembly of claim 1, wherein the torsion tube is curved in a first plane and in a second plane.

4. The hitch assembly of claim 3, wherein the first plane is substantially horizontal relative to the torsion tube and the second plane is substantially vertical relative to the torsion tube when the torsion tube is attached to the vehicle.

5. The hitch assembly of claim 3, wherein the curve in the first plane is at a first radius and the curve in the second plane is at a second radius, wherein the second radius is different from the first radius.

6. The hitch assembly of claim 1 further comprising a receiver assembly connected to the torsion tube.

7. The hitch assembly of claim 1, wherein the at least one bracket comprises a first frame bracket attached at a first end of the torsion tube and a second frame bracket attached at a second end of the torsion tube, the first and second brackets capable of being attached to the vehicle.

8. A hitch assembly comprising:
at least one bracket capable of attaching to a vehicle;
a torsion tube having first and second end portions, wherein at least one of the first and second end portions is attached to the at least one bracket; and
wherein at least a portion of the torsion tube is curved and the curve has a substantially constant radius.

9. The hitch assembly of claim 8, wherein the torsion tube includes a central portion between the first and second end portions wherein the curve of the torsion tube is located on the central portion.

10. The hitch assembly of claim 9 further comprising a receiver assembly attached to at least a portion of the central portion of the torsion tube.

11. The hitch assembly of claim 10, wherein the receiver assembly has a receiver curve having a receiver radius, wherein the receiver radius is substantially equal to the radius of the curve of the torsion tube.

12. The hitch assembly of claim 11, wherein the receiver assembly comprises:
a receiver tube attached to the torsion tube;
a channel support positioned below the receiver tube;
a back plate mounted behind the receiver tube and connected to the torsion tube; and
a chain plate mounted to a front portion of the torsion tube and substantially surrounding the receiver tube.

13. The hitch assembly of claim 8, wherein the torsion tube is a generally rectangular, tubular member.

14. The hitch assembly of claim 8, wherein the curve of the torsion tube is in a first plane at a first radius and in a second plane at a second radius.

15. The hitch assembly of claim 13, wherein the first radius is substantially equal to the second radius.

16. A hitch assembly comprising:
at least one frame bracket capable of attaching to a vehicle;
a torsion member having a length and being attached to the at least one frame bracket, the torsion member being curved at a substantially constant radius along at least a portion of the length; and
a receiver assembly attached to the torsion member.

17. The hitch assembly of claim 16, wherein the receiver assembly is attached to the torsion member along at least a portion of the curve of the torsion member.

18. The hitch assembly of claim 17, wherein the receiver assembly has a curved portion having a receiver radius substantially equal to the radius of the curve of the torsion member.

19. The hitch assembly of claim 16, wherein the torsion member is a tubular member.

20. The hitch assembly of claim 16, wherein the curve of the torsion member is in at least one of a first plane and a second plane.
